(19) United States
(12) Patent Application Publication
(10) Pub. No.: US 2008/0162266 A1
(43) Pub. Date: Jul. 3, 2008

(54) Business object acting as a logically central source for agreements on objectives

(75) Inventors: Jens Griessmann, Walldorf (DE); Klaus Herter, Leimen (DE); Arno Mielke, Karlsruhe (DE)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 11/647,967

(22) Filed: Dec. 29, 2006

(51) Int. Cl. G06F 17/30

(52) U.S. Cl. 705/10

(57) ABSTRACT

This disclosure provides various embodiments of a system and method for implementing a logically centralized source for agreements on objectives. In one aspect, the method identifies one or more requirements associated with a business entity for use in a business object stored within a logically centralized repository, the repository storing a plurality of business objects, identifies one or more proposed solutions associated with the identified requirements for use in the business object; and releases the business object upon approval. In some implementations, the requirements comprise at least one intended use of the business entity, at least one required behavior of the business entity, or at least one expectation of the business entity. In other implementations, the method may be further operable to identify one or more comments associated with subsequent processing of the one or more solutions.

### TECHNICAL FIELD

This invention relates to requirement solutions and, more particularly, to systems, methods, and software for implementing a logically centralized source for agreements on objectives.

### BACKGROUND

In general, various industries and businesses have adopted particular requirements and specifications forms with different structures and standards. In some industries, idea management systems and requirement management systems are used to organize the ideas and requirements of businesses. The best known approaches in many industries are the “contract specification” or “product specification” provided by the requesting party and the “requirement specification” or “functional specification” provided by the solution provider. Multiple standards for requirements and specifications currently exist for organizations to select from, for example, the Institute of Electrical and Electronics' Engineering (IEEE) Standards on Requirements, IEEE Std. 830-1998, and Software Requirement Specification (SRS), DIN 69905-VDI/VDE 3694-VDA 6.1. Some organizations elect to develop their own requirement and specification standards for organizational-wide use.

In some industries, the requirements and specifications standards may be similar for business and organizations collaborating on projects. However, in other, more frequent situations, the standards used by the requesting party and those used by the solution provider may be different, in effect creating confusion and conflicts during the sharing of data, instructions, and information within the product development. Additionally, current methods are tied to a single requirement or specification standard, allowing only information in certain formats to be included. In those situations, unique products may create problems for the parties involved through possible data mismatches or the inability to include some requirement or solution parameters based upon an incompatible standard. In other situations, an organization requiring a simple product may be forced into an unduly cumbersome requirement and specification standard, such that the design process becomes unnecessarily difficult to manage.

### SUMMARY

This disclosure provides various embodiments of software for implementing a logically centralized source for agreements on objectives. In one aspect, the software is operable to identify one or more requirements associated with a business entity for use in a business object stored within a logically centralized repository, the repository storing a plurality of business objects, identify one or more proposed solutions associated with the identified requirements for use in the business object, and release the business object upon approval. In some implementations, the requirements comprise at least one intended use of the business entity, at least one required behavior of the business entity, or at least one expectation of the business entity. In other implementations, the software may be further operable to identify one or more comments associated with subsequent processing of the one or more solutions.

The foregoing example software may also be defined as computer implementable methods. The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates a server environment implementing a logically centralized source for agreements on objectives according to particular implementations of the present disclosure;

FIG. 2 is a diagram illustrating a system for performing the requirement gathering process and solution creation environment as utilized by the example system of FIG. 1;

FIG. 3A is a diagram of a generic business object in a particular implementation of FIG. 1;

FIG. 3B is a diagram illustrating the hierarchical representation of a specific business object in another particular implementation of FIG. 1; and

FIG. 4 is a flowchart illustrating a method of using a business object to identify business entity requirements and associated solutions such that both may be reviewed by the requesting entity and solution provider to develop an acceptable solution in a particular implementation of FIG. 1.

### DETAILED DESCRIPTION

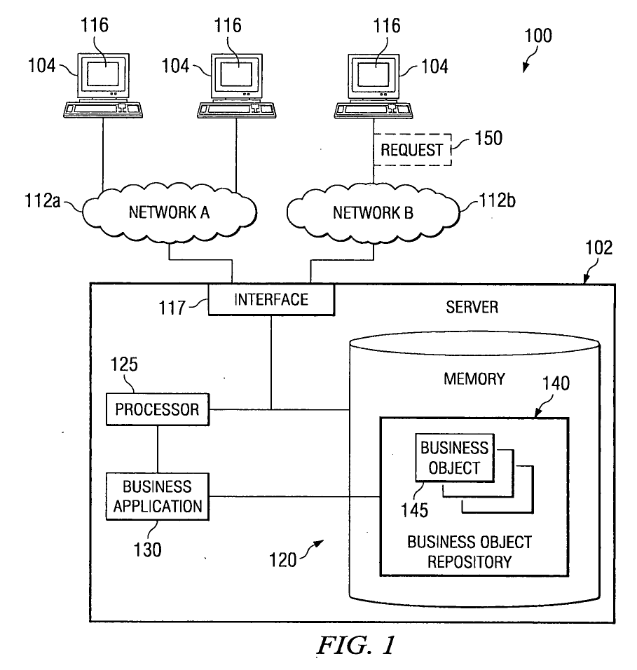

FIG. 1 illustrates a business environment 100 for storing or retrieving (or otherwise managing) information in at least a portion of an enterprise or data processing environment to implement a logically centralized source for agreements on objectives. In certain embodiments, environment 100 provides a business object 145 located within a business object repository 140 within which the requirements of a plurality of business entities may be collected, corresponding solutions to those requirements may be identified, and one or more of the corresponding solutions may be accepted as an agreement between a solution provider and a requesting entity. For example, a requesting party may have certain requirements for a product to be designed and subsequently manufactured. In some cases, the business object 145 allows for requirements of the requested product to be stored in a logically central location, in this instance the business object repository 140. The solution provider may be provided access to the plurality of requirements through the business object 145 such that proposed solutions may be identified. As the proposed solutions are identified, they may also be stored within the central location along with the identified requirements. There, the requesting entity may review the solutions through use of clients 104 present on network 112 of environment 100, and upon review, accept or reject particular solutions. If a proposed solution is accepted, users and/or applications of the environment 100 may access the agreed upon solution to review the various elements of the business object 145. In this manner, requesting entities and solution providers may interact within a centralized environment storing both the requirements and solutions such that the process of arriving at an agreed upon solution may be transparent to both parties, thus decreasing the time and effort required in the usual exchange of information. Indeed, the business object 145 may be searchable by other (perhaps authenticated) solution providers or requesting entities. In some situations, the solutions stored within business object 145 associated with a first requesting entity may be presented to a second requesting entity when the second requesting entity provides requirements similar to those of the first requesting entity. The presentation of the existing business object 145 may be performed automatically through an automated process recognizing the similarities of the requirements, or the presentation may be done manually by searching keywords, metadata, and other data associated with the business object 145.

Turning to the illustrated embodiment, environment 100 may be a distributed client/server system that allows clients 104 to submit requests to store and/or retrieve information from business object repository 145 maintained within memory 120 on server 102. But environment 100 may also be a standalone computing environment or any other suitable environment, such as an administrator accessing data stored on server 102, without departing from the scope of this disclosure. Environment 100 may allow access to individual business objects 145 within the business object repository 140 using access methods such as Java, COM/DCOM (Component Object Model/Distributed Component Object Model), CORBA (Common Object Request Broker Architecture), RFC (Remote Function Call), and Hypertext Transfer Protocol (HTTP), or other suitable access methods.

In the illustrated embodiment, server 102 includes memory 120 and processor 125 and comprises an electronic computing device operable to receive, transmit, process and store data associated with environment 100. For example, server 102 may be any computer or processing device such as a mainframe, a blade server, general-purpose personal computer (PC), Macintosh, workstation, Unix-based computer, or any other suitable device. Generally, FIG. 1 provides merely one example of computers that may be used with the disclosure. In other words, the present disclosure contemplates computers other than general purpose computers as well as computers without conventional operating systems. As used in this document, the term “computer” is intended to encompass a personal computer, workstation, network computer, or any other suitable processing device. For example, although FIG. 1 illustrates one server 102 that may be used with the disclosure, environment 100 can be implemented using computers other than servers, as well as a server pool. Server 102 may be adapted to execute any operating system 110 including z/OS, Linux-Intel or Linux/390, UNIX, Windows Server, or any other suitable operating system. According to one embodiment, server 102 may also include or be communicably coupled with a web server and/or an SMTP server.

Memory 120 may include any memory or database module and may take the form of volatile or non-volatile memory including, without limitation, magnetic media, optical media, random access memory (RAM), read-only memory (ROM), removable media, or any other suitable local or remote memory component. In this embodiment, illustrated memory 120 includes business object repository 140. In some embodiments, the business object repository 140 may be stored in one or more tables in a relational database described in terms of SQL statements or scripts. In the same or other embodiments, the business object repository 140 may also be formatted, stored, or defined as various data structures in text files, eXtensible Markup Language (“XML”) documents, Virtual Storage Access Method (“VSAM”) files, flat files, Btrieve files, comma-separated-value (“CSV”) files, internal variables, or one or more libraries. In short, the business object repository 140 may comprise one table or file or a plurality of tables or files stored on one computer or across a plurality of computers in any appropriate format. Indeed, some or all of the business object repository 140 may be local or remote without departing from the scope of this disclosure and store any type of appropriate data. In particular embodiments, the business object repository 140 may access the business objects 145 in response to queries from clients 104.

These business objects 145 may represent organized data relating to some project or endeavor, which may or may not be linked, with each object having one or more states related to the object. Each of the states, in turn, may be associated with data that pertains to various modifiable parameters of the individual states of the object. One type of data modeling that includes multiple objects with each having multiple states, and each state having multiple instances of changes to the state's modifiable parameters is the business object model. The overall structure of a business object model ensures the consistency of the interfaces that are derived from the business object model. The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Each business object is thus a capsule with an internal hierarchical structure, behavior offered by its operations, and integrity constraints. Business objects are generally semantically disjointed, i.e., the same business information is represented once. In some embodiments, the business objects are arranged in an ordering framework such that they can be arranged according to their existence dependency to each other. For example, in a modeling environment, the customizing elements might be arranged on the left side of the business object model, the strategic elements might be arranged in the center of the business object model, and the operative elements might be arranged on the right side of the business object model. Similarly, the business objects can be arranged in this model from the top to the bottom based on defined order of the business areas, e.g., finance could be arranged at the top of the business object model with customer relationship management (CRM) below finance and supplier relationship management (SRM) below CRM. To help ensure the consistency of interfaces, the business object model may be built using standardized data types as well as packages to group related elements together, and package templates and entity templates to specify the arrangement of packages and entities within the structure.

In one embodiment, business object repository 140 may be referenced by or communicably coupled with applications executing on or presented to client 104. In some embodiments, the business object repository 140 may be searchable, such as by requests 150 from clients 104 via the network 112. Distinct business objects 145, as well as multiple instances of a single business object 145, may be searched to allow the user and/or application to find a business object 145 type or a specific instance thereof on demand.

Server 102 also includes processor 125. Processor 125 executes instructions and manipulates data to perform the operations of server 102 such as, for example, a central processing unit (CPU), a blade, an application specific integrated circuit (ASIC), or a field-programmable gate array (FPGA). In particular, processor 125 performs any suitable tasks associated with business object repository 140. Although FIG. 1 illustrates a single processor 125 in server 102, multiple processors 125 may be used according to particular needs and reference to processor 125 is meant to include multiple processors 125 where applicable.

Server 102 may also include interface 117 for communicating with other computer systems, such as client 104, over network 112 in a client-server or other distributed environment. In certain embodiments, server 102 receives requests 150 for data access from local or remote senders through interface 117 for storage in memory 120 and/or processing by processor 125. Generally, interface 117 comprises logic encoded in software and/or hardware in a suitable combination and operable to communicate with network 112. More specifically, interface 117 may comprise software supporting one or more communications protocols associated with communications network 112 or hardware operable to communicate physical signals.

Server 102 may also include or reference a local, distributed, or hosted business application 130. At a high level, business application 130 is any application, program, module, process, or other software that may access, retrieve, modify, delete, or otherwise manage some information of the business object repository 140 in memory 120. Specifically, business application 130 may access the business object repository 140 to retrieve or modify data stored within specific business objects 145 as requested by a user and/or another application. Business application 130 may be considered business software or solution that is capable of interacting or integrating with business object repository 140 located, for example, in memory 120 to provide access to data for personal or business use. An example business application 130 may be a computer application for performing any suitable business process by implementing or executing a plurality of steps. One example of a business application 130 is an application that may provide interconnectivity with one or more business object repositories 140 containing product development information such that records may be dispersed among a plurality of business objects 145. As a result, business application 130 may provide a method of accessing requested data and presenting it to the user and/or application such that the user and/or application are provided information through a GUI interface 116 in a centralized manner. Business application 130 may also provide the user with a computer implementable method of implementing a centralized source for agreements on one or more solutions identified by a solution provider.

More specifically, business application 130 may be a composite application, or an application built on other applications, that includes an object access layer (OAL) and a service layer. In this example, application 130 may execute or provide a number of application services, such as CRM systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help composite application 130 to orchestrate a business process in synchronization with other existing processes (e.g., native processes of enterprise base systems) and leverage existing investments in the IT platform. Further, composite application 130 may run on a heterogeneous IT platform. In doing so, composite application 130 may be cross-functional in that it may drive business processes across different applications, technologies, and organizations. Accordingly, composite application 130 may drive end-to-end business processes across heterogeneous systems or sub-systems. Application 130 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes the composite application 130, it may instead be a standalone or (relatively) simple software program. Regardless, application 130 may also perform processing automatically, which may indicate that the appropriate processing is substantially performed by at least one component of system 100. It should be understood that this disclosure further contemplates any suitable administrator or other user interaction with application 130 or other components of system 100 without departing from its original scope. Finally, it will be understood that system 100 may utilize or be coupled with various instances of business applications 130. For example, client 104 may run a first business application 130 that is communicably coupled with a second business application 130. Each business application 130 may represent different solutions, versions, or modules available from one or a plurality of software providers or developed in-house.

For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's NET. Further, while illustrated as internal to server 102, one or more processes associated with application 130 may be stored, referenced, or executed remotely. For example, a portion of application 130 may be a web service that is remotely called, while another portion of application 130 may be an interface object bundled for processing at remote client 104. Moreover, application 130 may be a child or sub-module of another software module or enterprise application (not illustrated) without departing from the scope of this disclosure. Indeed, application 130 may be a hosted solution that allows multiple parties in different portions of the process to perform the respective processing. For example, client 104 may access application 130, once developed, on server 102 or even as a hosted application located over network 112 without departing from the scope of this disclosure. In another example, portions of software application 130 may be developed by the developer working directly at server 102, as well as remotely at client 104. Regardless of the particular implementation, “software” may include software, firmware, wired or programmed hardware, or any combination thereof as appropriate. Indeed, each of the foregoing software applications may be written or described in any appropriate computer language including C, C++, Java, Visual Basic, assembler, Perl, any suitable version of 4GL, as well as others. It will be understood that while these applications are shown as a single multi-tasked module that implements the various features and functionality through various objects, methods, or other processes, each may instead be a distributed application with multiple sub-modules. Further, while illustrated as internal to server 102, one or more processes associated with these applications may be stored, referenced, or executed remotely. Moreover, each of these software applications may be a child or sub-module of another software module or enterprise application (not illustrated) without departing from the scope of this disclosure.

Network 112 facilitates wireless or wireline communication between computer server 102 and any other local or remote computer, such as clients 104. Indeed, while illustrated as two networks, 112a and 112b respectively, network 112 may be a continuous network without departing from the scope of this disclosure, so long as at least portion of network 112 may facilitate communications between senders and recipients of requests 150 and results. In other words, network 112 encompasses any internal and/or external network, networks, sub-network, or combination thereof operable to facilitate communications between various computing components in environment 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations.

Client 104 is any local or remote computing device operable to receive requests from the user via a user interface 116, such as a GUI, a CLI (Command Line Interface), or any of numerous other user interfaces. Thus, where reference is made to a particular interface, it should be understood that any other user interface may be substituted in its place. In various embodiments, each client 104 includes at least GUI 116 and comprises an electronic computing device operable to receive, transmit, process and store any appropriate data associated with environment 100. It will be understood that there may be any number of clients 104 communicably coupled to server 102. For example, illustrated clients 104 include one local client 104 and two clients external to the illustrated portion of enterprise 100. Further, “client 104” and “user” may be used interchangeably as appropriate without departing from the scope of this disclosure. Moreover, for ease of illustration, each client 104 is described in terms of being used by one user. But this disclosure contemplates that many users may use one computer or that one user may use multiple computers to submit or review queries via GUI 116. As used in this disclosure, client 104 is intended to encompass a personal computer, touch screen terminal, workstation, network computer, kiosk, wireless data port, wireless or wireline phone, personal data assistant (PDA), one or more processors within these or other devices, or any other suitable processing device. For example, client 104 may comprise a computer that includes an input device, such as a keypad, touch screen, mouse, or other device that can accept information, and an output device that conveys information associated with the operation of server 102 or clients 104, including digital data, visual information, or GUI 116. Both the input device and output device may include fixed or removable storage media such as a magnetic computer disk, CD-ROM, or other suitable media to both receive input from and provide output to users of clients 104 through the display, namely GUI 116.

GUI 116 comprises a graphical user interface operable to allow the user of client 104 to interface with at least a portion of environment 100 for any suitable purpose. Generally, GUI 116 provides the user of client 104 with an efficient and user-friendly presentation of data provided by or communicated within environment 100. GUI 116 may provide access to the front-end of business application 130 executing on client 104 that is operable to access one or more business objects 145 stored within business object repository 140. In another example, GUI 116 may display output reports such as summary and detailed reports. GUI 116 may comprise a plurality of customizable frames or views having interactive fields, pull-down lists, and buttons operated by the user. In one embodiment, GUI 116 presents information associated with queries 150 and buttons and receives commands from the user of client 104 via one of the input devices. Moreover, it should be understood that the term graphical user interface may be used in the singular or in the plural to describe one or more graphical user interfaces and each of the displays of a particular graphical user interface. Therefore, GUI 116 contemplates any graphical user interface, such as a generic web browser or touch screen, that processes information in environment 100 and efficiently presents the results to the user. Server 102 can accept data from client 104 via the web browser (e.g., Microsoft Internet Explorer or Mozilla Firefox) and return the appropriate HTML or XML responses using network 112. For example, server 102 may receive a request 150 from client 104 using the web browser and then execute the request 150 to store and/or retrieve information and data from a business object 145 stored within business object repository 140.

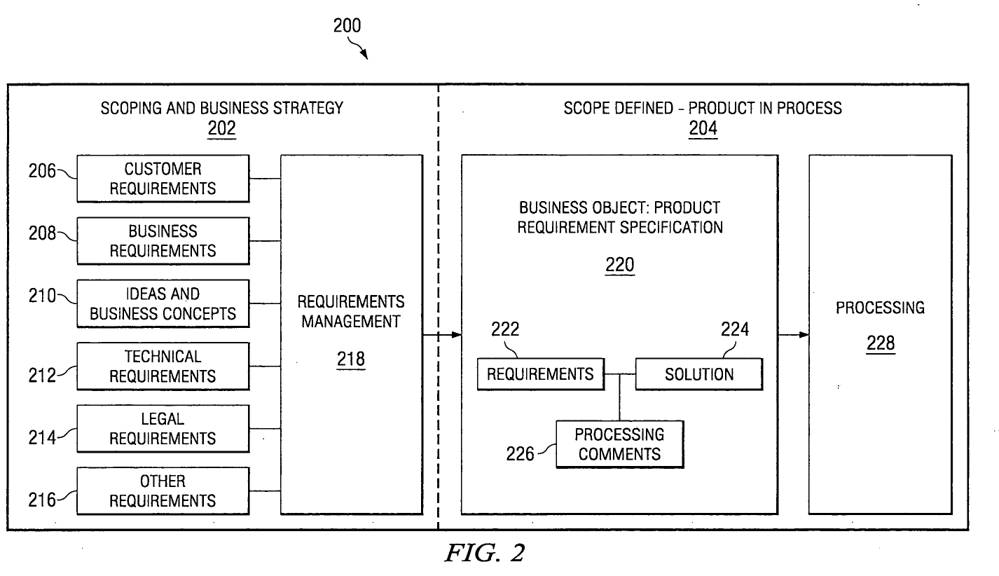

FIG. 2 illustrates an example system implementing a logically centralized source for agreements on objectives for a business entity. A business entity may be defined as a product, such as machinery, a software application, or a service, that may be priced, ordered, purchased, or maintained. The business entity may also be a package comprising a combination of products, such that the package itself may be defined as a business entity. Generally, a business entity may be represented as a good, service, intermediate part, or other item, such that it is produced or created upon the request or need of a requesting party and designed or manufactured by a solution provider.

System 200 of FIG. 2 is divided into two example parts—(1) scoping and business strategy 202 and (2) scope defined/product in process 204. Scoping and business strategy 202 illustrates an example of the plurality of sources that govern the definition of a business entity's scope and requirements. In the example embodiment of FIG. 2, those inputs include customer requirements 206, business requirements 208, ideas and business concepts 210, technical requirements 212, legal requirements 214, and other requirements 216.

Customer requirements 206 may list the tasks and goals of the customer. Customer requirements 206 may be intended to make an existing business entity easier to use or faster, or define the intended uses and effects of a new business entity. Business requirements 208 may list the goals of the business. At the highest level, the business goals 208 may include the increase of revenue, a decrease of costs, a specific improvement of the existing business entity, an improvement of the business entity's efficiency, and so on. Ideas and business concepts 210 may include earlier versions of the business entity designed by the customer or the requesting entity, specific ideas regarding the functionality or implementations of the business entity, as well as other concepts developed prior to developing the requirements. The ideas and business concepts 210 may be considered requirements in the sense that they indicate a type or example of the solution desired. Technical requirements 212 may include the hardware and software integration issues such as security, compatibility, performance requirements, and the like. In a product manufacturing example, technical requirements 212 may include manufacturing requirements such as the conditions, processes, materials, and/or tools required. The technical requirements 212 may be high-level requirements, such as requiring a business entity to possess networking capabilities, or specific requirements such as providing that specific portions of programming code be included within the solution. Legal requirements 214 may include notices required to be on or within a business entity, legal minimums for specifications that should be met (e.g. car safety standards), as well as labor requirements that the provided solution should meet in producing the business entity. Additionally, the other requirements 216 represent those requirements not specifically included above that may be provided by the requesting party. Some examples may include the development processes, methods, and techniques that may be used in development of the business entity, as well as other various requirements. This list of requirements is not meant to be exclusive, but rather an example of the sources for requirements present in the embodiment of FIG. 2.

Requirements management system 218 acts as conduit for the various requirements generated in the scoping and business strategy 202 section of FIG. 2. Requirements management may be defined as the art of gathering and managing requirements within a business entity development project. In some examples, requirements management system 218 may be embodied as a particular third party commercial requirements management tool. In other examples, the requirements management system 218 may represent a manual collection of the requirements identified in the scoping and business strategy 202 stage of FIG. 2. The manual collection of requirements may be performed by an individual, a team of persons, or through various collaborations within a computerized document. Regardless of its specific embodiment, the requirements management system 218 collects the identified requirements and provides them to the business object 220.

Business object 220 resides in the scope defined/product in progress 204 section of system 200. This section represents the system once the scope and requirements of the business entity have been defined, and the process of providing a solution to meet those defined requirements begins. In the present example, business object 220 is named Product Requirement Specification. Within the business object 220 may reside the identified requirements 222, proposed solutions 224 meeting those requirements, and processing comments 226 included for when the business entity enters the actual processing phase of development. The identified requirements 222 may represent the collection of requirements as collected by the requirements management system 218 during the scoping and business strategy 202 portion of FIG. 2. Those requirements may be provided to the business object 220 and stored therein as requirements 222.

Once the scope is defined, the solution provider may offer solutions fulfilling the identified requirements 222. In one example, the solution provider may identify or specify one overall solution for the requirements. This solution can be described by several specification items that give a response to the requirement items. In some cases, multiple solutions may be identified such that a plurality of solutions, perhaps utilizing various vendors or suppliers, are offered and (occasionally prioritized). Each solution may be included within one business object 220 such that the solutions 224 component contains a plurality of identified specification items for review by the requesting party as well as by members of the solution provider. Each solution may include multiple documents, such as a detailed specification, a feasibility determination, concept figures, as well as others. Regardless of the form taken, each solution may be a precise, complete, and quantifiable description of the identified solution such that the requirements of the requesting party may be met and/or exceeded. The solutions 224 component may be viewable by both the requesting party and the solution provider. In some examples, the solutions may be viewable prior to their completion. In that manner, the requesting party may interact with the solutions provider in order to assist in the development process. For instance, the requesting party may, while viewing a solution in progress, provide feedback and commentary to the solution provider such that the solution being developed more closely realizes the business entity desired by the requesting party. As the single location for the identified solutions, solutions 224 component provides a method for requesting parties to stay up-to-date on potential solutions and become an active player in the design process, helping to facilitate better solutions at a quicker pace.

The information within business object 220 may focus specifically on the requirements 222 and solutions 224 for the business entity as opposed to the processing of the entity after agreement on a particular solution by the parties. While business object 220 may not include a processing layer, it may include a processing comments 226 component. The processing comments 226 component represents comments related to the processing stage of development. For instance, the use of a specific brand of materials for a client may be included in the processing comments 226 based on client preference, where the specific brand was not a part of the requirements 222 or identified solutions 224. These processing comments 226 may be hidden from the requesting party such that only the solution provider may view them. In those situations, the processing comments 226 may remain internal to the solution provider, allowing the processing comments 226 to act as a clipboard for notes, reminders, and other relevant information not included within the agreed upon solution.

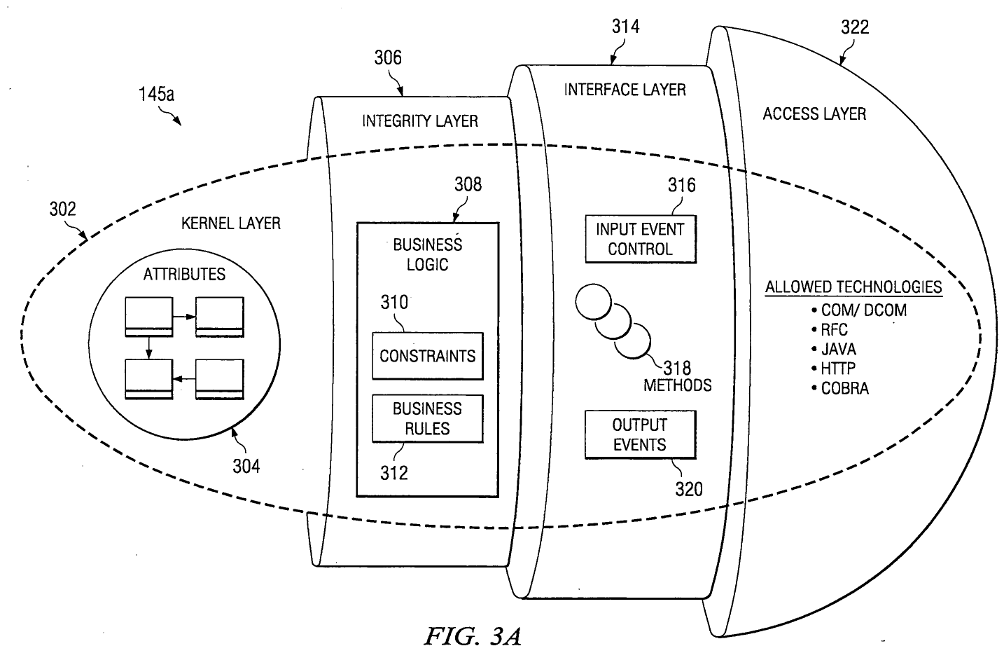

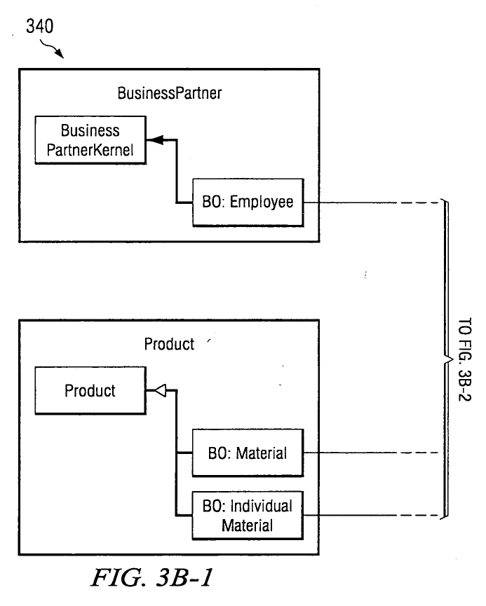

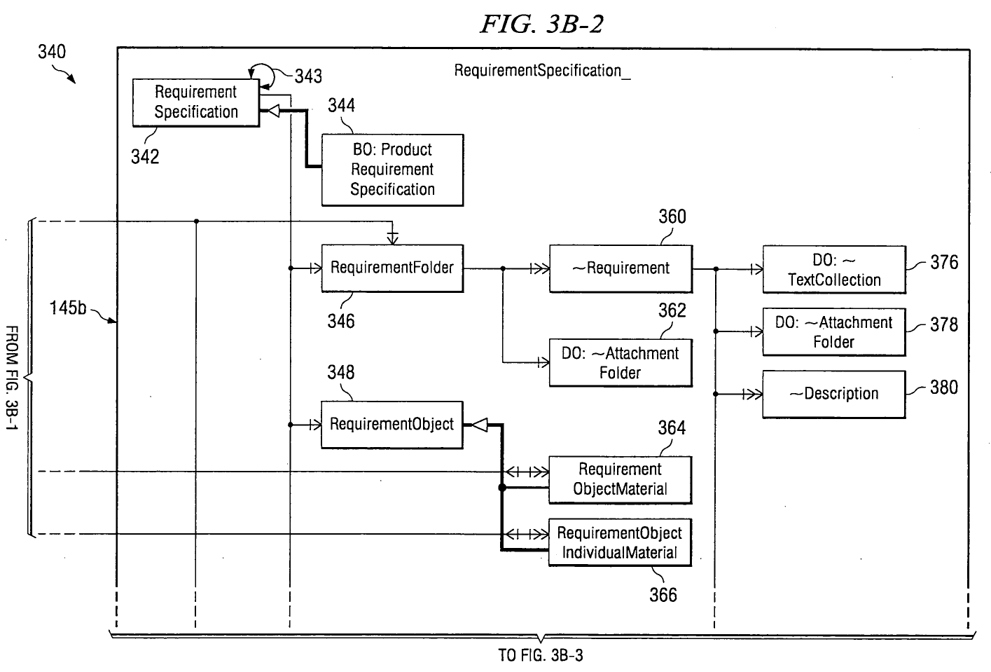

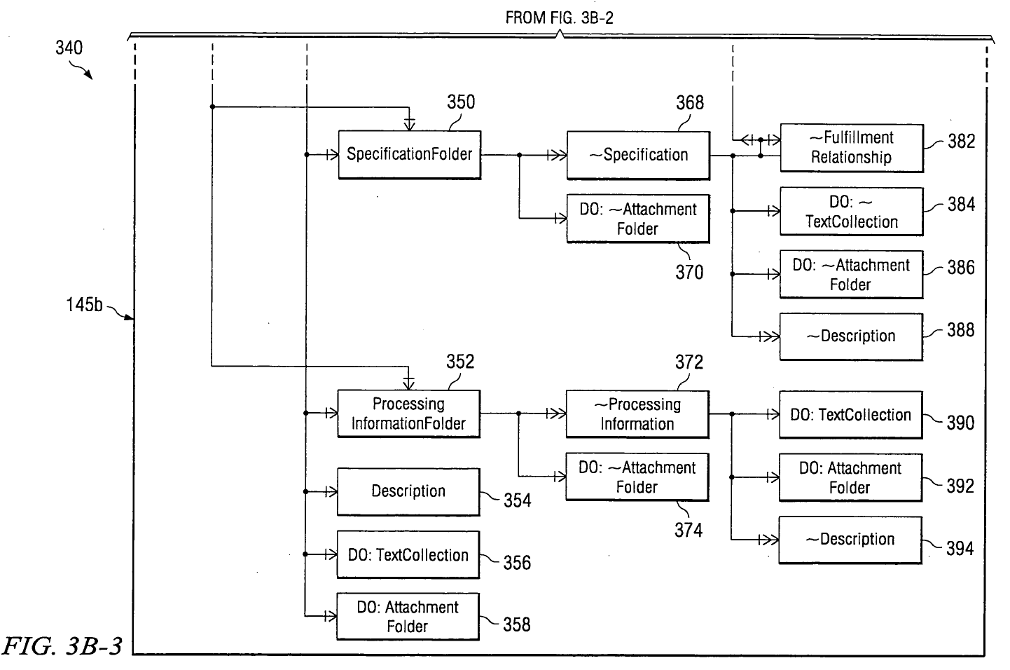

In the scope defined/product in process 204 section, the business object 220 may later be used in processing 228. The identified solution 224 that has been agreed upon by the parties may be provided to a processing entity 228 for manufacturing, development, or further processing. The processing entity 228 may represent the same or another section of the solution provider, a manufacturing unit of the requesting party, or a third-party who will be processing or manufacturing the business entity defined by the business object 220. In this way, business object 220 may be independent of the processing stage, allowing for the requesting party to focus on well-defined requirements as opposed to the final product itself, thus resulting in better solution development. The business object 220 will be explained in detail through FIGS. 3A and 3B.

FIG. 3A illustrates the structure of a generic business object 145a in environment 100. In general, the overall structure of the business object model ensures the consistency of the interfaces that are derived from the business object model. The derivation helps ensure that the same business-related subject matter or concept can be represented and structured in the same way in various interfaces. The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

A business object is a capsule with an internal hierarchical structure, behavior offered by its operations, and integrity constraints. Business objects are semantically disjointed, i.e., the same business information is represented once. A business object may be defined such that it contains multiple layers, such as in the example business object 145 of FIG. 3A. The example business object 145 contains four layers: the kernel layer 302, the integrity layer 306, the interface layer 314, and the access layer 322. The innermost layer of the example business object is the kernel layer 302. The kernel layer 302 represents the business object's 145 inherent data, containing various attributes of the defined business object. The second layer represents the integrity layer 306. In the example business object 145, the integrity layer 306 contains the business logic 308 of the object. Such logic may include business rules 312 for consistent embedding in the environment 100 and the constraints 310 regarding the values and domains that apply to the business object 145. Business logic 308 may comprise statements that define or constrain some aspect of the business, such that they are intended to assert business structure or to control or influence the behavior of the business entity. It may pertain to the facts recorded on data and constraints on changes to that data. In effect, business logic 308 may determine what data may, or may not, be recorded in business object 145a. The third layer, the interface layer 314, may supply the valid options for accessing the business object 145 and describe the implementation, structure, and interface of the business object to the outside world. To do so, the interface layer 314 may contain methods 318, input event controls 316, and output events 320. The fourth and outermost layer of the business object 145 in FIG. 3A is the access layer 322. The access layer 322 defines the technologies that may be used for external access to the business object's 145 data. Some examples of allowed technologies may include COM/DCOM (Component Object Model/Distributed Component Object Model), CORBA (Common Object Request Broker Architecture), RFC (Remote Function Call), Hypertext Transfer Protocol (HTTP) and Java, among others. Additionally, business objects 145a of this embodiment may implement standard object-oriented technologies such as encapsulation, inheritance, and/or polymorphism.

FIG. 3B illustrates another example of a business object 145b represented in a hierarchically arranged structure 340. The following provides a brief overview of the business object model. In the business object model, the business object 145 may be arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects may be arranged from the top to the bottom based on defined order of the business areas.

To ensure the consistency of interfaces, the business object model may be built using standardized data types as well as packages to group related elements together, and package templates and entity templates to specify the arrangement of packages and entities within the structure.

Data Types

Data types are used to type object entities and interfaces with a structure. This typing can include business semantic. For example, the data type BusinessTransactionDocumentID is a unique identifier for a document in a business transaction. Also, as an example, data type BusinessTransactionDocumentParty contains the information that is exchanged in business documents about a party involved in a business transaction, and includes the party's identity, the party's address, the party's contact person and the contact person's address. BusinessTransactionDocumentParty also includes the role of the party, e.g., a buyer, seller, product recipient, or vendor.

The data types are based on Core Component Types (“CCTs”), which themselves can be based on the World Wide Web Consortium (“W3C”) data types. “Global” data types represent a business situation that is described by a fixed structure. Global data types include both context-neutral generic data types (“GDTs”) and context-based context data types (“CDTs”). GDTs contain business semantics, but are application-neutral, i.e., without context. CDTs, on the other hand, are based on GDTs and form either a use-specific view of the GDTs, or a context-specific assembly of GDTs or CDTs. A message is typically constructed with reference to a use and is thus a use-specific assembly of GDTs and CDTs. The data types can be aggregated to complex data types.

To achieve a harmonization across business objects and interfaces, the same subject matter is typically typed with the same data type. For example, the data type “GeoCoordinates” is built using the data type “Measure” so that the measures in a GeoCoordinate (i.e., the latitude measure and the longitude measure) are represented the same as other “Measures” that appear in the business object model.

Entities

Entities are discrete business elements that are used during a business transaction. Entities are not to be confused with business entities or the components that interact to perform a transaction. Rather, “entities” are one of the layers of the business object model and the interfaces. For example, a Catalogue entity is used in a Catalogue Publication Request and a Purchase Order entity is used in a Purchase Order Request. These entities are created using the data types defined above to ensure the consistent representation of data throughout the entities.

Packages

Packages group the entities in the business object model and the resulting interfaces into groups of semantically associated information. Packages also may include “sub”-packages, i.e., the packages may be nested.

In the example of FIG. 3B, the business object 145b is named RequirementSpecification, and contains information relating to the requirements 222, the solutions 224, and the processing comments 226 components of FIG. 2. Each instance of RequirementSpecification is a unique version and has its own VersionUUID. Instances that belong to the same business entity share the same ID. Two instances of RequirementSpecification have a different ID if they are not versions of the same business entity, such as window shutters for two different buildings of different customers.

The business object named RequirementSpecification 145b is divided into three main parts: RequirementFolder 346, SpecificationFolder 350, and ProcessingInformationFolder 352. The first part is the RequirementFolder 346, representing the collection of requirements for a business entity within a given business context (e.g. a Prototype, Development Project, Sales Order). The second part is the corresponding SpecificationFolder 350 covering specifications to define the properties of the intended use and behavior of this business entity, defined by the requirements. The third part is the collection of information relevant for in-house processing represented by the ProcessingInformationFolder 352. The RequirementObject 348 specifies the Object(s) that are necessary to fulfill the RequirementSpecification.

The elements located directly at the root node RequirementSpecification may be defined by the data type RequirementSpecificationElements. These elements may include VersionUUID, ID, VersionID, SystemAdministrativeData, Name, RequirementSpecificationKey, and Status. The following composition relationships to subordinate notes may exist:

| | |
|---|---|
| Description | 1:cn |
| RequirementSpecificationRelationship | 1:cn |
| RequirementFolder | 1:c |
| RequirementObject | 1:cn |
| SpecificationFolder | 1:c |
| ProcessingInformationFolder | 1:c |
| TextCollection (DO) | 1:c |
| AttachmentFolder (DO) | 1:c. |

Queries to RequirementSpecification 145b may be performed as a QueryByKey, QueryByElements, or SelectAll. QueryByKey may deliver a list of RequirementSpecifications for a given UUID, ID, or Version ID combination. The query elements are defined by the data type RequirementSpecificationIDQueryElements. QueryByElements may deliver a list of RequirementSpecifications for given Elements, which may have been queried by parameters, which exist in the UI of the RequirementSpecifications. The query elements may be defined by the data type RquirementSpecificationElementsQueryElements, and may include UUID, ID, VersionID, SystemAdministrativeData, CreationBusinessPartnerCommonPersonNameGivenName, CreationBusinessPartner CommonPersonNameFamilyName, LastChangeBusinessPartnerCommonPersonName GivenName, LastChangeBusinessPartnerCommonPersonNameFamilyName, Name, Status, RequirementFolderResponsibleEmployeeUUID, RequirementFolder ResponsibleEmployeeID, RequirementFolderResponsibleGivenName, RequirementFolderResponsibleFamilyName, RequirementID, RequirementName, RequirementCreationProcessingStatusCode, RequirementSolutionProposalStatusCode, MaterialUUID, MaterialID, IndividualMaterialUUID, and IndividualMaterialID. SelectAll may be used to select appropriate entries in the business object 145b.

Description 354 may be a representation of the properties of a RequirementSpecification in natural language. The elements located at the description node may be defined by the data type RequirementSpecificationDescriptionElements. These elements may include description, as well as other elements. TextCollection (DO) 356 may be a natural-language text describing the RequirementSpecification 342, and the AttachmentFolder (DO) may be an electronic document of any type, such as a word document, drawing, note, or other type, whose content is related to the RequirementSpecification 342 under examination.

RequirementSpecificationRelationship 343 refers to the relationship of two instances of a RequirementSpecification 145b such that a definition of a common context exists. When a complex business entity is requested, several instances of RequirementSpecification 145b may be reasonable to distinguish between different areas of the requirements. Nevertheless, those instances may be linked to each other to express a common context. An example for a common context may be the relationship between a RequirementSpecification 145b in a customer quotation and another RequirementSpecification in a subsequent sales order. The elements located at the node RequirementSpecificationRelationship may be defined by the data type RequirementSpecificationRelationshipElements. These elements may include UUID, VersionUUID, RequirementSpecificationKey, RequirementSpecificationID, and RequirementSpecificationVersionID. In order to build a relationship between two instances of RequirementSpecification 145b, at least the UUID of the RequirementSpecification 145b or the RequirementSpecificationKey is typically provided.

RequirementFolder 350 may be a collection of requirements needed for a business entity. It may include the central information that is relevant for subsequent single requirements. RequirementFolder 350 may be introduced to separate assigned Requirements from Specifications and Processing Information. Therefore, RequirementFolder 350 acts a common anchor for assigned Requirements. The elements located at the node RequirementFolder may be defined by the data type RequirementSpecificationFolderElements. These elements may include UUID, ResponsibleEmployeeUUID, ResponsibleEmployeeID, Status, and SystemAdministrativeData. The following composition relationships to subordinate notes may exist:

| | |
|---|---|
| RequirementFolderRequirement | 1:cn |
| RequirementFolderAttachmentFolder (DO) | 1:c. |

RequirementFolderRequirement 360 may be a natural-language or property-based description of direct needs and expectations relevant for a planned or existing business entity. The contents of the RequirementFolderRequirement 360 may be in contrast to a specification in that the requirements do not need to be precise or complete and detailed, but they may be required to contain essential properties. Typical qualifiers may include good, regular, not relevant, easy, or stable. One example of the RequirementFolderRequirement 360 may be a window shutter the requirement for handling that includes the following options: manual handling, handling from inside with less expenditure of energy, or automatic handling. The elements located at the node RequirementFolderRequirement 360 may be defined by the data type RequirementSpecificationRequirementFolderRequirementElements. These elements may include UUID, ID, Name, RequirementPriorityCode, Status, or SystemAdministrativeData. The following composition relationships to subordinate nodes exist:

| | |
|---|---|
| Description | 1:cn |
| RequirementFolderRequirementTextCollection (DO) | 1:c |
| RequirementFolderRequirementAttachmentFolder (DO) | 1:c. |

RequirementFolderRequirementDescription 380 may be a representation of the properties of a RequirementFolderRequirement 360 in natural language. The elements located at the description node may be defined by the data type RequirementSpecificationRequirementFolderRequirementDescriptionElements. One example of the elements therein may be a Description element. RequirementFolderRequirementTextCollection (DO) 376 may be natural-language text describing the RequirementFolderRequirement 360. RequirementFolderRequirementAttachmentFolder (DO) 378 may be an electronic document of any type, such as a word document, drawing, note, or other type, whose content is related to the RequirementFolderRequirement 360 under examination. RequirementFolderAttachmentFolder (DO) may be an electronic document of any type, whose content is related to the RequirementFolder 346 under examination.

RequirementObject 348 may be a business object that is requested to fulfill the requirements. The basic information may be the type of the required business object, which may be, for example, a material. Furthermore, a RequirementObject 348 may also contain administrative information. RequirementObject 348 occurs in the following disjoint and incomplete specializations: RequirementObjectMaterial 364 and RequirementObjectIndividualMaterial 366. The specializations may specify the business object connected to the RequirementSpecification 342. The RequirementObject 348 occurs, at maximum, only once in the specialization of a RequirementObjectMaterial 364 and only once in the specialization of a RequirementObjectIndividualMaterial 366. For each specialization at least a Material, Individual Material, or a Product Category assignment should exist. RequirementObjectMaterial 364 may define a material that is supposed to fulfill the RequirementSpecification 342. In addition, a RequirementObjectMaterial 364 contains identifying information including, for example, UUID, ID, and SystemAdministrativeData. RequirementObjectIndividualMaterial 366 may represent an Individual Material that is the material that is supposed to fulfill the RequirementSpecification 342. In addition, a RequirementObjectIndividualMaterial 366 may contain identifying information such as UUID, ID, and SystemAdministrativeData.

SpecificationFolder 350 may be a collection of one or more specifications that define the fulfillment of the requirements of a business entity. It may cover the information that is relevant for subsequent single specifications. The SpecificationFolder 350 may be introduced to separate the assigned specifications against requirements and processing information. It may therefore act as a common anchor for assigned specifications. The elements located at the node SpecificationFolder 350 may be defined by the data type RequirementSpecificationSpecificationFolderElements. These elements may include UUID, ResponsibleEmployeeUUID, ResponsibleEmployeeID, Status, and SystemAdministrativeData. The following composition relationships to subordinate nodes may exist:

| | |
|---|---|
| SpecificationFolderSpecification | 1:cn |
| SpecificationFolderAttachmentFolder (DO) | 1:c. |

SpecificationFolderSpecification 368 may be the precise definition of one or more features and how they fulfill one or more requirements of the business entity. In contrast to a requirement, the content of a specification may be precise, complete and quantifiable or measurable. It may combine technical, legal or other constraints that may define the usage, behavior, and maintenance of the delivered business entity with a focus on the requirements. It may also include warnings in case of abuse. The specification is not a design or implementation and therefore does not contain the design. The elements located at the node SpecificationFolderSpecification 368 may be defined by the data type RequirementSpecificationSpecificationFolderSpecificationElements. These elements may include UUID, ID, Name, Status, and SystemAdministrativeData. The following composition relationships to subordinate nodes may exist:

| | |
|---|---|
| Description | 1:cn |
| SpecificationFolderSpecificationFulfilmentRelationship | 1:cn |
| SpecificationFolderSpecification TextCollection (DO) | 1:c |
| SpecificationFolderSpecificationAttachmentFolder (DO) | 1:c. |

SpecificationDescription 388 may be a representation of the properties of a SpecificationFolderSpecification 368 in natural language. The elements located at the description node may be defined by the data type RequirementSpecificationSpecificationFolderSpecificationDescriptionElements. One example of the elements therein may be Description. SpecificationFolderSpecificationTextCollection (DO) 384 may be a natural-language text describing the SpecificationFolderSpecification 368. SpecificationFolderSpecification AttachmentFolder (DO) 386 may be an electronic document of any type, such as a word document, drawing, note, or other type, whose content is related to the SpecificationFolderSpecification 368 under examination. SpecificationFolderSpecificationFulfilmentRelationship 352 may define a relationship of a specification that contributes to the fulfillment of one or multiple requirements. During the creation process of specifications it may be important to assign such a specification to one or more requirements, even if a specification is not yet released and the fulfillment of the requirement(s) has not been approved. This may allow the determination of whether specifications are already in process in the early stages of development. In some cases no specification is required for requirements. If that is the case, then these requirements are marked as self-specified by a corresponding status value. For example, a window shutter business entity that has the requirement “manual handling, handling from inside with less expenditure of energy” may be fulfilled by multiple solutions (handling by belt, crank or lever). With the assignment of a specification to the requirement, it will be documented how the requirement will be fulfilled, such as by “handling by crank”. The elements located at the node SpecificationFolderSpecificationFulfimentRelationship may be defined by the data type SpecificationFolderSpecificationFulfimentRelationshipElement. These elements may include SpecificationFolderSpecificationUUID, RequierementFolderRequirementUUID, and SystemAdministrativeData. SpecificationFolderAttachmentFolder (DO) 386 may be an electronic document of any type, such as a word document, drawing, note, or other type, whose content is related to the SpecificationFolder 350 under examination.

ProcessingInformationFolder 352 may be a collection of information that is relevant for the subsequent processing of the business entity in terms of, for example, production, storage and transportation. In contrast to the content of the SpecificationFolderSpecification 368, the enclosed information may be intended primarily for a manufacturer's internal use. This content may be strongly related to the entire value chain that is to provide the business entity. Therefore this information may be hidden and considered as not relevant to an external customer. The elements located at the node ProcessingInformationFolder 352 may be defined by the data type RequirementSpecificationProcessingInformationFolder Elements. These elements may include UUID, ResponsibleEmployeeUUID, ResponsibleEmployeeID, Status, and SystemAdministrativeData. The following composition relationships to subordinate nodes may exist:

| | |
|---|---|
| ProcessingInformationFolderProcessingInformation | 1:cn |
| ProcessingInformationFolderAttachmentFolder (DO) | 1:c. |

ProcessingInformationFolderProcessingInformation 372 may be any definition, information or instruction that is important for an optimized in-house processing, for example, in terms of production, packaging or storage. This set of information may be intended for in-house processing but not limited to it. In the case of collaboration between manufacturers, the manufacturers may want to share this information because they share the value chain of the business entity. It may need to be outlined that the stakeholder of the requested business entity does not need to know this information and is typically not allowed to know it. The elements located at the ProcessingInformationFolderProcessingInformation 372 may be defined by the data type RequirementSpecificationProcessingInformationFolderProcessingInformationElements. These elements may include UUID, ID, Name, and SystemAdministrativeData. Additionally, the following composition relationships to subordinate nodes may exist:

| | |
|---|---|
| Description | 1:cn |
| ProcessingInformationFolderProcessingInformationTextCollection (DO) | 1:c |
| ProcessingInformationFolderProcessingInformationAttachmentFolder (DO) | 1:c. |

ProcessingInformationFolderProcessingInformationDescription 394 may be a representation of the properties of a ProcessingInformationFolderProcessingInformation 372 in natural language. The elements located at the description node are defined by the data type RequirementSpecificationProcessingInformationFolder ProcessingInformationDescriptionElements. These elements may include Description and other elements. ProcessingInformationFolderProcessingInformationTextCollection (DO) 390 may be a natural-language text describing the ProcessingInformationFolderProcessingInformation 372. ProcessingInformationFolder ProcessingInformationAttachmentFolder (DO) 392 may be an electronic document of any type, such as a word document, drawing, note, or other type, the content of which is related to the ProcessingInformationFolderProcessingInformation 372 under examination. ProcessingInformationFolderAttachmentFolder (DO) 374 may be an electronic document of any type, the content of which is related to the ProcessingInformationFolder 352 under examination.

The hierarchical structure of FIG. 3B and the portions of business object 145b represent one example of a business object 145b in environment 100. In other implementations, different structures and elements may comprise the system. Accordingly, the above description does not define or constrain the disclosure to the particular embodiment shown.

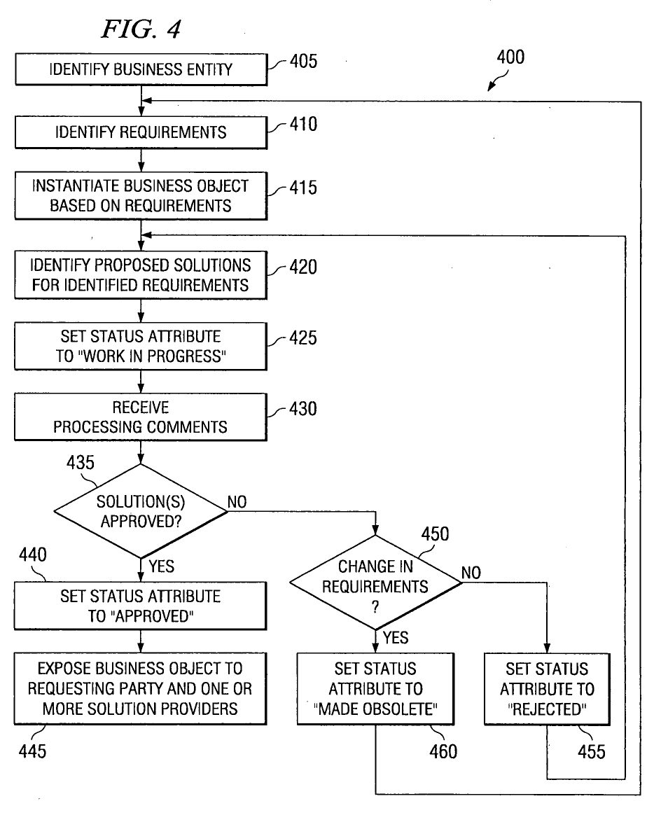

FIG. 4 is a flowchart diagram illustrating method 400 for implementing a logically centralized source for agreements on objectives through the use of a business object 145 in which the requirements and solutions for a business entity may be collected. Method 400 starts with a business entity being identified at step 405. Identifying a business entity entails the process where the requesting party defines the product or service it wants to develop. For example, the business entities identified may be a golf club generating additional distance, a more efficient automobile engine, or a streamlined customer service process for a call center. Identifying the business entity may include setting the goals or defining the intended outcome of a product or service to be designed. A business entity may be loosely defined such that upon taking the requirements of the requesting entity, the solution provider may provide multiple solutions encompassing multiple variations of the ultimate business entity produced.

Once the business entity is defined in step 505, the requesting party identifies the requirements that the business entity should meet in order to be acceptable. As listed in the description of FIG. 2, some examples of requirements identified may include customer requirements 206, business requirements 208, ideas and business concepts 210, technical requirements 212, legal requirements 214, and other assorted requirements 216. In a large organization, identifying the requirements may include a large-scale request for requirements from multiple departments and employees. In a smaller organization, a small group of individuals, or possibly a single employee, may be responsible for identifying the requirements of a business entity. Some requirements may originate outside the requesting party, such as legal requirements defined by law or technical standards adopted by an industry. Additionally, some requirements may be identified by a third party for whom the requesting party may be providing the business entity. Regardless of the requirements' origin, step 410 includes providing them to a requirements management system 218 for centralized storage.

Once the requirements have been collected by the requirement management system 218, a business object 145 is instantiated at step 415 with attributes based on the requirements provided in step 410. Instantiating a business object 145 involves the creation of a new instance of the business object 145 shown in FIG. 1. The structure of the business object 145 may be structured similar to business objects 145a or 145b of FIGS. 2 and 3, respectively. When instantiated, the business object 145 receives the requirements from the requirements management system 218 and populates the attributes into the business object 145 structure. In addition to the attributes provided by the requirements management system 218, other attributes may be set. For instance, an ownership attribute may be set as to reflect the person responsible for creating the current instance of the business object 145. Additionally, a status attribute associated with the business object 145 may track the progress of the current instance, such as by providing entities interacting with the business object 145 a quick indication of the current status of the design process. Upon instantiation, the status attribute may be set to indicate that no solutions have yet been provided, for example, through an attribute value of “initialized.” Status attributes may be set for both the requirement 222 component and the solution 224 component. The business object 145 in this example may be used in a plurality of instances, such that a plurality of business objects 145 may be associated with a plurality of business entities. In this way, the business object 145 may be used with any type of business entities, from basic products to detailed procedures. As such, the business object 145 offers a scalable and flexible approach to the design process that allows business and organizations of any size an easy-to-use method for designing business entities.

When the business object 145 is populated with attributes from the requirements management system 218, the requirements may be stored with the requirements 222 component of the business object 145. The requirements 222 component may be accessible to the solution provider such that solutions may be identified that suit the identified requirements at step 420. The proposed solutions may be identified by the solutions provider by storing them within the solution 224 component of the business object 145. The solutions may be stored in a manner similar to business object 145b of FIG. 3B, such that the data is stored in a hierarchical manner within the specification folder 350. As solutions are identified, they are accessible by the requesting party, for example, through a GUI 116 on client 104 of FIG. 1. In this manner, the requesting party may be active in the solution development stage of the design, providing valuable real-time feedback on the work of the solution provider. By integrating the feedback received, solution providers may develop acceptable solutions to the requesting party's requirements at a quicker pace due to earlier and more frequent feedback. At step 420, one solution or many solutions may be identified in any given iteration of the method 400.

When a solution or a portion thereof is identified, the status attribute may be set at step 425 to the value of “work in progress,” or another value such that the requesting party is given notice that a solution has been identified. Notice of the status attribute change may be provided automatically, such as through an automated email, or requesting entities may be required to manually research whether the status attribute has changed. At step 430, any associated processing comments may be received by the business object 145. These comments may represent information primarily for a manufacturer's internal use. The content may be strongly related to the entire value chain that is to provide the business entity. As such, the information may be hidden from the requesting entity, allowing only the solution provider and others authorized by the solution provider to view the comments.

At step 435, the requesting entity may review one or more of the identified solutions to determine whether or not an acceptable solution has been provided. The requesting entity may decide whether a solution is acceptable through a comparison to the requirements identified in step 410, a cost-benefit analysis of the proposed solution, or other methods of evaluation. If the solution is approved, the method 400 proceeds to step 440 where the status attribute of the accepted solution may be set to a value reflecting the acceptance such as “approved” or “released.” Once the status attribute has been modified, method 400 proceeds to step 445 where the business object 145 and the approved solution may be exposed to the requesting party, the solution provider, and other parties as deemed necessary, such as a contractor performing the actual manufacturing or creation of the business entity. Once the accepted solution is exposed, illustrated method 400 can be considered complete.

If, at step 435, the identified solutions are not approved, then method 400 may proceed to step 450. At step 450, system 100 decides whether there has been a change in the requirements since the non-approved solutions were identified. If the requirements have remained constant, then method 400 continues to step 455 wherein the status attribute of the identified solutions are set to “rejected” or a similar value, indicating that the solutions have been reviewed but were not deemed acceptable by the requesting party. Once the attribute has been set, the method 400 returns to step 420, and new proposed solutions to the identified requirements may be identified. From there, method 400 continues on through the process. If the requirements have changed (or some other similar issue arises) as shown as decisional step 450, the status attribute of the proposed solutions may be set to “made obsolete” or a similar value. The proposed solutions may no longer be a solution for the business entity, such that method 400 returns to step 410 to re-identify the requirements. Once the new requirements are identified, method 400 proceeds as initially created until an identified solution is approved and the agreed upon solution is released to the parties.

The preceding flowchart and accompanying description illustrate exemplary method 400. Environment 100 contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, environment 100 may use methods with additional steps, fewer steps, and/or different steps, so long as the methods remain appropriate.

Although this disclosure has been described in terms of certain embodiments and generally associated methods, alterations and permutations of these embodiments and methods will be apparent to those skilled in the art. Accordingly, the above description of example embodiments does not define or constrain the disclosure. Other changes, substitutions, and alterations are also possible without departing from the spirit and scope of this disclosure, and such changes, substitutions, and alterations may be included within the scope of the claims included herewith.

What is claimed is:

1. Software comprising instructions stored on a computer readable medium, the software operable when executed to:
identify one or more requirements associated with a business entity for use in a business object stored within a logically centralized repository, the repository storing a plurality of business objects;
identify one or more proposed solutions associated with the identified requirements for use in the business object; and
release the business object upon approval.

2. The software of claim 1, wherein the identified requirements comprise at least one intended use of the at least one business entity, at least one required behavior of the at least one business entity, at least one expectation of the at least one business entity, or any other suitable information associated with the at least one business entity.

3. The software of claim 1, wherein the identified requirements comprise at least the essential requirements of the business entity.

4. The software of claim 1, wherein each of the requirements include at least one associated attribute.

5. The software of claim 4, wherein one associated attribute comprises a status attribute that defines whether the one or more identified requirements has been solved, rejected, or made obsolete.

6. The software of claim 4, wherein one associated attribute comprises an ownership attribute that comprises ownership information for the particular identified requirement.

7. The software of claim 1, wherein the particular business entity comprises machinery, a software application, a service, or a combination thereof.

8. The software of claim 7, the particular business entity operable to be priced, ordered, purchased, and maintained

9. The software of claim 1 further operable when executed to identify one or more comments associated with subsequent processing of the one or more solutions.

10. The software of claim 9, the identified requirements received from a requesting business and the software further operable to hide the comments from the requesting business.

11. The software of claim 1, wherein the identified requirements are represented by hierarchically arranged structures that are independent of a solution provider.

12. The software of claim 10, wherein the hierarchically arranged structures are defined by one or more elements wherein the elements are comprised of one or more of the following: documents, drawings, notes, or other suitable data.

13. The software of claim 1, wherein the business objects stored in the central repository are searchable.

14. The software of claim 13, the requirements received from a first requesting business and the software further operable to:
identify one or more requirements associated with the business entity by a second requesting entity; and
present the particular business object to the second requesting entity, the business object identified using one or more of the requirements by the second requesting entity.

15. A computerized method for implementing a logically centralized source for agreements on objectives, comprising:
identifying one or more requirements associated with a business entity for use in a business object stored within a logically centralized repository, the repository storing a plurality of business objects;
identifying one or more proposed solutions associated with the identified requirements for use in the business object; and
releasing the business object upon approval.

16. The method of claim 15, wherein the identified requirements comprise at least one intended use of the at least one business entity, at least one required behavior of the at least one business entity, at least one expectation of the at least one business entity, or any other suitable information associated with the at least one business entity.

17. The method of claim 15, wherein the identified requirements comprise at least the essential requirements of the business entity.

18. The method of claim 15, wherein each of the requirements include at least one associated attribute.

19. The method of claim 18, wherein one associated attribute comprises a status attribute that defines whether the one or more identified requirements has been solved, rejected, or made obsolete.

20. The method of claim 18, wherein one associated attribute comprises an ownership attribute that comprises ownership information for the particular identified requirement.

21. The method of claim 15 further comprising identifying one or more comments associated with subsequent processing of the one or more solutions.

22. The method of claim 21, the identified requirements received from a requesting business and the method further comprising hiding the comments from the requesting business.

23. The method of claim 15, wherein the identified requirements are represented by hierarchically arranged structures that are independent of a solution provider.

24. The method of claim 23, wherein the hierarchically arranged structures are defined by one or more elements wherein the elements are comprised of one or more of the following: documents, drawings, notes, or other suitable data.

25. The method of claim 15, wherein the business objects stored in the central repository are searchable.

26. The method of claim 25, the requirements received from a first requesting business and the method further comprising:
identifying one or more requirements associated with the business entity by a second requesting entity; and
presenting the particular business object to the second requesting entity, the business object identified using one or more of the requirements by the second requesting entity.

27. A system for implementing a logically centralized source for agreements on objectives, comprising:
means for identifying one or more requirements associated with a business entity for use in a business object stored within a logically centralized repository, the repository storing a plurality of business objects;
means for identifying one or more proposed solutions associated with the identified requirements for use in the business object; and
means for releasing the business object upon approval.

28. The system of claim 27, wherein the identified requirements comprise at least one intended use of the at least one business entity, at least one required behavior of the at least one business entity, at least one expectation of the at least one business entity, or any other suitable information associated with the at least one business entity.

29. The system of claim 27, wherein the identified requirements comprise at least the essential requirements of the business entity.

30. The system of claim 27, wherein each of the identified requirements include at least one associated attribute an at least one associated attribute comprises a status attribute that defines whether the one or more identified requirements has been solved, rejected, or made obsolete.

31. The system of claim 30, wherein one associated attribute comprises an ownership attribute that comprises ownership information for the particular identified requirement.

32. The system of claim 27 further comprising means for identifying one or more comments associated with subsequent processing of the one or more solutions, the identified requirements received from a requesting business and the system further comprising means for hiding the comments from the requesting business.

33. The system of claim 27, wherein the identified requirements are represented by hierarchically arranged structures that are independent of a solution provider, wherein the hierarchically arranged structures are defined by one or more elements and at least one element comprises of one or more of the following: documents, drawings, notes, or other suitable data.

34. The system of claim 27, wherein the business objects stored in the central repository are searchable and the requirements received from a first requesting business, the system further comprising:
means for identifying one or more requirements associated with the business entity by a second requesting entity; and
means for presenting the particular business object to the second requesting entity, the business object identified using one or more of the requirements by the second requesting entity.
